(19) United States
(12) Patent Application Publication
(10) Pub. No.: US 2026/0251128 A1
(43) Pub. Date: Aug. 27, 2026

(54) ENERGY STORAGE STRUCTURE AND ROTARY ISOLATION SWITCH

(71) Applicant: Chint Low Voltage Electrical Technology Co., Ltd., Songjiang District, Shanghai (CN)

(72) Inventors: Zhe GU, Songjiang District, Shanghai (CN); Jiapeng JIANG, Songjiang District, Shanghai (CN); Kejie TANG, Songjiang District, Shanghai (CN); Weijun GE, Songjiang District, Shanghai (CN); Zhangqing ZHOU, Songjiang District, Shanghai (CN)

(21) Appl. No.: 18/992,973

(22) PCT Filed: Oct. 14, 2023
(86) PCT No.: PCT/CN2023/124629

§ 371 Date: Jan. 9, 2025

(30) Foreign Application Priority Data
Jan. 13, 2023 (CN) 202310062186.2

(51) Int. Cl. F03G 1/02; F03G 1/08; H02J 15/30

(52) U.S. Cl. CPC F03G 1/026; H02J 15/30; F03G 1/029; F03G 1/08

(57) ABSTRACT

An energy storage structure includes an operating shaft rotatable between a closing position and an opening position, a delayed energy storage mechanism and a locking mechanism. The delayed energy storage mechanism includes a first energy storage spring and a turntable in driving fit with the operating shaft and rotatable between an energy release position and an energy storage position. The locking mechanism locks the turntable at the energy storage position; when the operating shaft rotates from the opening position to the closing position, the turntable rotates from the energy release position to the energy storage position with the rotation of the operating shaft, and drives the first energy storage spring to store energy at the same time; the turntable is coaxially arranged with the operating shaft; and when or before the operating shaft arrives at the closing position, the turntable arrives at the energy storage position.

### TECHNICAL FIELD

The present invention relates to the field of low-voltage electrical appliances, in particular to an energy storage structure and a rotary isolation switch including the energy storage structure.

### BACKGROUND

With the wide application of rotary isolation switches, new functional requirements are put forward for rotary isolation switches: that is, the rotary isolation switch has a remote tripping function when a system line has a fault and can be manually closed after the fault is cleared, while the remote tripping function does not affect manual closing and opening operations of the isolation switch.

The existing rotary isolation switch with a remote tripping function achieves a remote tripping function by providing a delayed energy storage mechanism. Because of structural constraints, an energy storage process of the delayed energy storage mechanism and a switch closing operation cannot be carried out synchronously, so the switch closing operation must be completed first, and then the delayed energy storage mechanism completes energy storage. Hence, after the switch is operated to be closed, it is likely for an operator to mistakenly think that the energy storage of the delayed energy storage mechanism has been completed, resulting in failure of energy storage. The remote opening operation cannot be carried out when the system line has a fault, leading to potential safety hazards.

In addition, in the existing rotary isolation switch with the remote tripping function, a structure for achieving the remote tripping function without affecting manual opening and closing operations of the isolation switch is complex, and is cumbersome to install.

In addition, in the existing rotary isolation switch with the remote tripping function, a spring of the delayed energy storage mechanism is sleeved on an operating shaft and is in contact with the operating shaft, such that parts are easily worn, and the action performance is affected by the friction of the spring and the operating shaft. For example, the friction of the spring and the operating shaft causes power attenuation. When a friction force is greater than a power output of the spring, the rotary isolation switch is caused to appear in an abnormal state between closing and opening, that is, causes the opening operation to fail.

### SUMMARY

An object of the present invention is to overcome at least one defect of the prior art, and to provide an energy storage structure and a rotary isolation switch including the energy storage structure, achieving a reliable and stable remote opening control function.

In order to achieve the above object, the present invention adopts the following technical solutions:
an energy storage structure, comprising an operating shaft, a delayed energy storage mechanism and a locking mechanism, wherein the delayed energy storage mechanism comprises a first energy storage spring and a turntable;
the operating shaft rotates between an opening position and a closing position, the turntable rotates between an energy release position and an energy storage position, and the locking mechanism is used for locking the turntable at the energy storage position;
the operating shaft is in driving fit with the turntable, and when the operating shaft rotates from the opening position to the closing position, the turntable rotates from the energy release position to the energy storage position with the rotation of the operating shaft, and drives the first energy storage spring to store energy at the same time; and
the turntable is coaxially arranged with the operating shaft; and when or before the operating shaft arrives at the closing position, the turntable arrives at the energy storage position.

Further, the locking mechanism comprises a lock catch, and the lock catch comprises a lock catch latching portion;
the turntable comprises a locking arm latching surface, and the locking arm latching surface is in locking fit with the lock catch latching portion, so that the turntable is kept at the energy storage position; and
when or before the operating shaft arrives at the closing position, the locking arm latching surface rotates past the lock catch latching portion.

Further, the turntable comprises a first surface, a driving finger is arranged on the operating shaft, and the driving finger is in transmission fit with the first surface to drive the turntable to rotate toward the energy storage position;
one end of the locking arm latching surface away from a rotation axis of the turntable is offset to a side, where the first surface is located, with respect to one end of the locking arm latching surface close to the rotation axis of the turntable;
the locking arm latching surface is located on an outer side of the first surface in a radial direction of the turntable; and
an included angle between extended surfaces of the locking arm latching surface and the first surface is greater than or equal to 0° and less than or equal to 10°.

Further, when the locking mechanism unlocks the turntable, the first energy storage spring releases energy and drives the turntable to rotate from the energy storage position to the energy release position, and the turntable drives the operating shaft to rotate from the closing position to the opening position.

Further, the turntable comprises a turntable shaft hole and at least one turntable driven hole, the operating shaft passes through the turntable shaft hole, and a side wall of the turntable driven hole is provided with first surface.

Further, when the turntable is located at the energy storage position, the operating shaft rotates freely between the opening position and the closing position.

Further, there is an opening idle stroke between the turntable and the operating shaft; and when the operating shaft rotates from the closing position to the opening position, the operating shaft travels through the opening idle stroke with respect to the turntable.

Further, the opening idle stroke is arranged in the turntable driven hole; and when the turntable is located at the energy storage position and the operating shaft rotates from the closing position to the opening position, the driving finger travels through the opening idle stroke and the turntable remains stationary.

Further, the turntable driven hole is a sector-shaped hole, a circle center of which coincides with an axis of the turntable; the first surface and a second surface are arranged at both ends of the sector-shaped hole in a circumferential direction thereof, respectively; and the opening idle stroke is arranged between the first surface and the second surface.

Further, the two sector-shaped holes are symmetrically formed in two radial sides of the operating shaft. The delayed energy storage mechanism further includes a driving key arranged on the operating shaft, and both ends of the driving key protrude from both ends of the two radial sides of the operating shaft as two driving fingers.

Further, the turntable further comprises a turntable main plate and a turntable locking arm; the turntable driven hole is formed in the turntable main plate; the turntable locking arm is arranged on an edge of the turntable; the locking arm latching surface is arranged on an edge of the turntable locking arm; and the locking arm latching surface is not coplanar with the turntable main plate.

Further, the energy storage structure further comprising a first bushing that is rotatably sleeved on the operating shaft; and the first energy storage spring is a torsion spring sleeved on the first bushing, wherein one end of the torsion spring is matched with the turntable, and another end of the torsion spring is fixedly arranged.

Further, the first bushing is coaxially and fixedly connected to and arranged in synchronous rotation with the turntable.

Further, the first bushing is provided with bushing protrusions, the turntable is provided with turntable holes, and the bushing protrusions are inserted in the turntable holes.

Further, the first bushing is provided with two sets of bushing protrusions. The sector-shaped holes of the turntable are used as the turntable holes, the two sets of bushing protrusions are respectively arranged in the two sets of sector-shaped holes of the turntable, and the driving keys are located between the two sets of bushing protrusions.

Further, the energy storage structure further comprising a housing upper cover, a housing diaphragm and a gasket, wherein one end of the first bushing is in limiting fit with the housing upper cover, and another end of the first bushing body is matched with the turntable; the gasket is arranged on the housing diaphragm as a turntable bearing structure; and the turntable is arranged on the gasket.

Further, the first bushing comprises a first bushing head and a first bushing body that are coaxially arranged; the first bushing head has an outer diameter greater than an outer diameter of the first bushing body and an outer diameter of a first spring coil body; and one end of the first bushing body is connected to the first bushing head, another end of the first bushing body is matched with the turntable, and the first spring coil body is sleeved on the first bushing body.

A rotary isolation switch includes the energy storage structure.

According to the energy storage structure of the present invention, a delayed energy storage mechanism can complete energy storage in a closing operation process of an operating shaft, that is, the delayed energy storage mechanism completes energy storage before or when the operating mechanism is closed, so as to avoid the failure of remote opening control operation caused by the failure of energy storage.

In addition, a switching idle stroke is arranged between a first surface and a second surface, thereby achieving a remote tripping function without affecting the manual opening and closing operations, and a simple structure, and being is easy to produce and assemble.

In addition, the first energy storage spring is sleeved on a first bushing, so that the operating shaft can be prevented from being locked when the energy storage spring twists and stores energy, and the first energy storage spring can be well fixed to prevent its deflection, thereby ensuring the reliable and stable operation of the delayed energy storage mechanism. The first bushing cooperates with a turntable to limit the turntable on a turntable bearing structure, which is conducive to keeping the turntable in a horizontal state (that is, a state perpendicular to an axial direction of the operating shaft), avoiding the turntable from warping under a torsional torque of the first energy storage spring, and ensuring the reliable and stable operation of the delayed energy storage mechanism.

In addition, the first bushing is coaxially and fixedly connected to and rotates synchronously the turntable, and provides radial support for the turntable, which avoids radial friction between the turntable and the operating shaft, improves the action fluency of the turntable, also reduces the wear of the turntable and the operating shaft, and prolongs the service life of the product.

The rotary isolation switch of the present invention includes the energy storage structure having a reliable and stable remote opening control function, thereby ensuring the reliable and stable operation of the rotary isolating switch.

### BRIEF DESCRIPTION OF THE DRAWINGS

FIG. 1 is a schematic structural diagram of an isolation switch in the present invention;

FIG. 2 is a projection view of a delayed energy storage mechanism, a locking mechanism and a tripping mechanism in the present invention, in which the delayed energy storage mechanism is in an energy release state;

FIG. 3 is a schematic diagram of a three-dimensional structure of the delayed energy storage mechanism, the locking mechanism and the tripping mechanism in the present invention in one perspective, in which the delayed energy storage mechanism is in an energy storage process;

FIG. 4 is a projection view of the delayed energy storage mechanism, the locking mechanism and the tripping mechanism in the present invention, in which the delayed energy storage mechanism is in an energy storage state;

FIG. 5 is a schematic diagram of a three-dimensional structure of the delayed energy storage mechanism, the locking mechanism and the tripping mechanism in the present invention in another perspective, in which the delayed energy storage mechanism is in the energy storage state;

FIG. 6 is an exploded view of the delayed energy storage mechanism in the present invention;

FIG. 7 is a schematic diagram of an assembly structure of a turntable, an operating shaft, a driving key, a gasket and a housing diaphragm in the present invention;

FIG. 8a is a schematic diagram of a three-dimensional structure of the turntable in the present invention;

FIG. 8b is a projection view of the turntable in the present invention;

FIG. 9 is a schematic structural diagram of a first bushing in the present invention; and

FIG. 10 is a schematic sectional view of a device housing in the present invention.

### REFERENCE SYMBOL REPRESENTS THE FOLLOWING COMPONENT

1—operating device; 1-1—housing base; 1-2—housing diaphragm; 1-25—housing diaphragm spring limiting groove; 1-26—turntable stopper; 1-3—housing upper cover; 100s—first space; 200s—second space; p—partition plate; 1-4—operating shaft; 1-40—operating shaft insertion hole; 1-5—gasket; 1-6—lock catch; 1-60—lock catch main plate; 1-61—lock catch latching portion; 1-7r—lock catch resetting element; 1-7—first bushing; 1-70—first bushing body; 1-71—first bushing head; 1-72—bushing protrusion; 1-8—first energy storage spring; 1-80—first spring fixed end; 1-81—first spring driven end; 1-9—turntable; 1-90—turntable main plate; 1-91—turntable shaft hole; 1-92—turntable locking arm; 1-920—turntable locking arm matching surface; 1-921—locking arm latching surface; 1-93—turntable matching arm; 1-930—turntable matching arm matching side edge; 1-931—turntable matching arm limiting side edge; 1-94—turntable driven hole; 1-940—first surface; 1-941—second surface; 1-10—driving key; 1-11—tripping unit; 2—switch body; and 4—handle.

### DETAILED DESCRIPTION OF THE INVENTION

The specific implementation of an energy storage structure of the present invention will be further described below with reference to the embodiments given in accompanying diagrams. The energy storage structure of the present invention is not limited to the description of the following embodiments.

The present invention discloses an isolation switch, preferably a rotary isolation switch, further preferably a remotely controlled rotary isolation switch.

As shown in FIG. 1, the isolation switch of the present invention includes an operating device 1 and a switch body 2 which are in driving connection with each other, wherein the operation device 1 drives the switch body 2 to connect or disconnect a circuit.

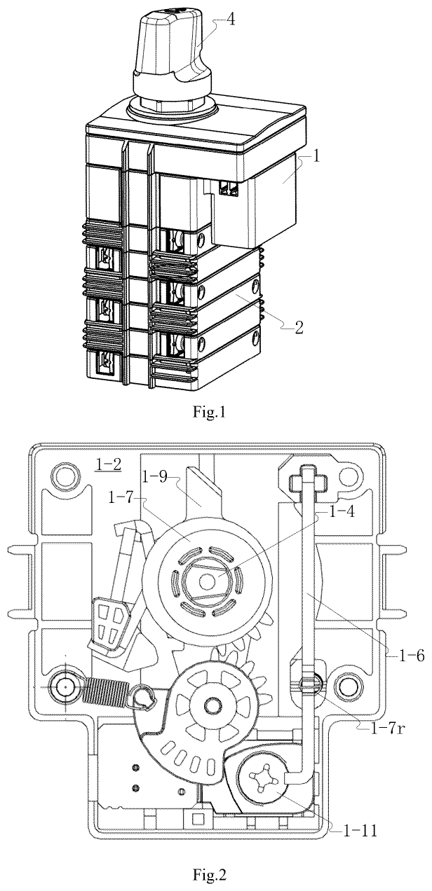

As shown in FIGS. 2-7, the operating device 1 includes an energy storage structure, a real-time energy storage mechanism (not shown) and a tripping mechanism. The energy storage structure includes an operating shaft 1-4 rotatably arranged around its own axis, a delayed energy storage mechanism and a locking mechanism. The operating shaft 1-4 is used for driving the real-time energy storage mechanism and the delayed energy storage mechanism to store energy. The operating shaft 1-4 can rotate between an opening position and a closing position. The operating shaft 1-4 drives the real-time energy storage mechanism to store energy first and then release energy while rotating, such that the operating device 1 drives the switch body 2 to be opened and closed normally. The operating shaft 1-4 drives the delayed energy storage mechanism to store energy while rotating from the opening position to the closing position. The locking mechanism is used for locking the delayed energy storage mechanism in an energy storage state. The tripping mechanism is used for triggering the locking mechanism to release locking fit with the delayed energy storage mechanism, such that the delayed energy storage mechanism releases energy, and the operating device 1 drives the switch body 2 to be opened. The tripping mechanism can be remotely controlled, thereby achieving a remote opening control function of the isolation switch. Further, the operating shaft 1-4 rotates reciprocally in two opposite directions so as to rotate between the opening position and the closing position.

As shown in FIGS. 1 and 10, the operating device 1 further includes a device housing. The delayed energy storage mechanism, the real-time energy storage mechanism, the locking mechanism and the tripping mechanism are all arranged in the device housing. Further, as shown in FIG. 10, the device housing includes a first space 100s and a second space 200s arranged in an axial direction of the operating shaft 1-4. A partition plate p is arranged between the first space 100s and the second space 200s, the delayed energy storage mechanism is arranged in the first space 100s, and the real-time energy storage mechanism is arranged in the second space 200s. The partition plate p is provided with a diaphragm shaft hole for the operating shaft 1-4 to pass through. The operating shaft 1-4 is rotatably inserted in the first space 100s and the second space 200s and cooperates with the delayed energy storage mechanism and the real-time energy storage mechanism respectively. One end of the operating shaft 1-4 protrudes out of the device housing for operation, and the other end of the operating shaft 1-4 is inserted into the second space 200s after passing through the first space 100s and the partition plate p sequentially. Further, the device housing includes a housing upper cover 1-3, a housing diaphragm 1-2 and a housing base 1-1 which cooperates with each other in sequence. The housing upper cover 1-3 and the housing diaphragm 1-2 are buckled to form the first space 100s. The housing diaphragm 1-2 and the housing base 1-1 are buckled to form the second space 200s. The housing diaphragm 1-2 includes the partition plate p.

As shown in FIG. 1, the operating device 1 further includes a handle 4. One end of the operating shaft 1-4 away from the real-time energy storage mechanism is an operating shaft connecting end used for being in plug-in connection with the handle 4. An external force drives the operating shaft 1-4 to rotate between the closing position and the opening position through the handle 4.

The real-time energy storage mechanism includes a second energy storage spring. When the operating shaft 1-4 rotates between the opening position and the closing position, the second energy storage spring is driven to store energy first and then release it, so as to drive the operating device 1 to be quickly switched between the closed state and the opened state, thereby driving the switch body 2 to quickly disconnect or connect the circuit. That is, the operating shaft 1-4 is used to output an opening or closing operation force to the real-time energy storage mechanism, so that the real-time energy storage mechanism can store energy first and then release it. Further, in the energy storage process of the second energy storage spring, the switch body 2 does not act. When the second energy storage spring releases energy, the switch body 2 is driven to quickly disconnect or connect the circuit. That is, in the manual opening or closing process, the second energy storage spring store energy first and then release it. The real-time energy storage mechanism can be implemented according to the prior art, and its detailed structure is not described herein.

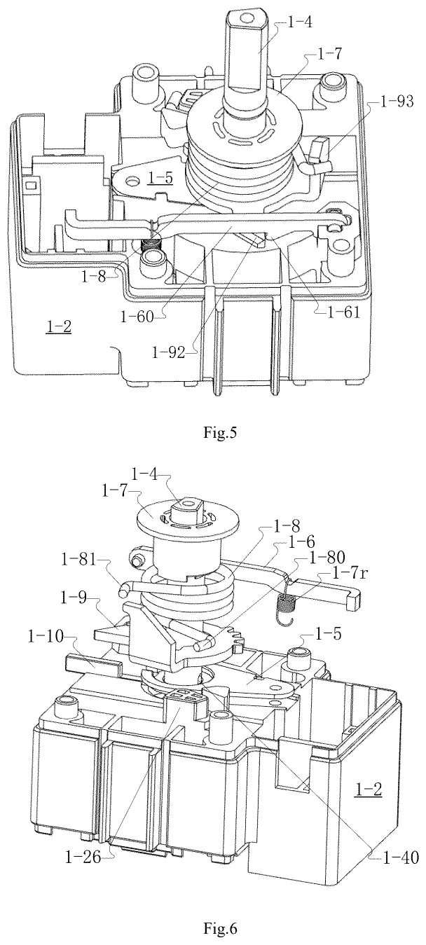

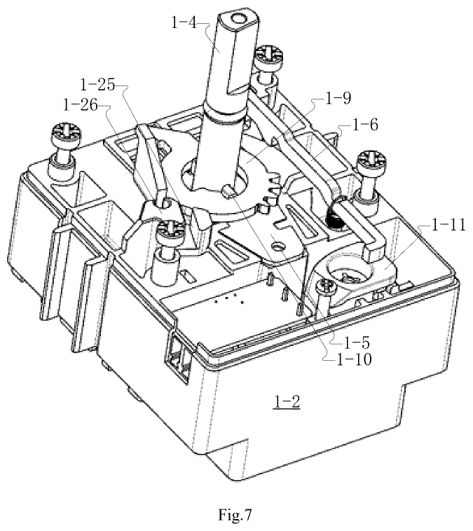

As shown in FIGS. 5-6, an embodiment of the delayed energy storage mechanism is shown.

In the case that the operating device 1 is in the opened state, when the operating shaft 1-4 rotates from the opening position to the closing position, the delayed energy storage mechanism is driven to be switched from an energy release state to an energy storage state and is in locking fit with the locking mechanism to keep in the energy storage state. When the delayed energy storage mechanism is in the energy storage state, the operating shaft 1-4 can be freely switched between the closing position and the opening position under an external force, without changing a state of the delayed energy storage mechanism. In the case that the operating device 1 in the closed state, when the tripping mechanism receives a remote opening signal and acts, the locking mechanism is driven to release locking fit from the delayed energy storage mechanism, the delayed energy storage mechanism releases energy and drives the operating device 1 to be switched from the closed state to the opened state, and the operating device 1 drives the switch body 2 to disconnect the circuit. Further, when the operating device 1 is in the closed state, the delayed energy storage mechanism releases energy and drives the operating shaft 1-4 to rotate from the closing position to the opening position, and then the operating shaft 1-4 drives the operating device 1 to be switched to the opened state through the real-time energy storage mechanism. That is, a transmission path when the delayed energy storage mechanism drives the operating device 1 to be opened is as follows: the delayed energy storage mechanism→the operating shaft 1-4→the real-time energy storage mechanism. Compared with the delayed energy storage mechanism of the prior art which directly acts on the real-time energy storage mechanism, the overall structure of the operating device is simplified, and the working stability and reliability are improved. The rotary isolation switch in this embodiment, regardless of being manually operated or remotely controlled, needs to output an opening or closing operation force through the operating shaft 1-4, and completes the opening operation or closing operation through the real-time energy storage mechanism.

As shown in FIGS. 2-7, an improvement point of the present application lies in the delayed energy storage mechanism:
the delayed energy storage mechanism in the present embodiment includes a turntable 1-9 and a first energy storage spring 1-8; the turntable 1-9 can rotate between an energy release position and an energy storage position, the operating shaft 1-4 is in driving fit with the turntable 1-9, the operating shaft 1-4 drives the turntable 1-9 to rotate from the energy release position to the energy storage position in the process of rotating from the opening position to the closing position, and the turntable 1-9 drives the first energy storage spring 1-8 to store energy, so that the first energy storage spring 1-8 is switched to the energy storage state; the turntable 1-9 is locked by the locking mechanism at the energy storage position, so that the turntable 1-9 is kept at the energy storage position and is prevented from rotating to the energy release position; when or before the operating shaft 1-4 arrives at the closing position, the turntable 1-9 arrives at the energy storage position, that is, when or before the operating shaft 1-4 completes the closing operation, the delayed energy storage mechanism completes energy storage. In the existing rotary isolation switch, the resetting of a tripping unit of the operating device and the action of the delayed energy storage mechanism are performed separately; when proceeding closing operation, only completing the closing operation, and then completing the energy storage operation of the delayed energy storage mechanism, and then can the resetting of the tripping unit be completed while the delayed energy storage mechanism completes the energy storage operation. The above-mentioned sequence is a fixed sequence. Once the above-mentioned sequence is adjusted, the closing operation cannot be completed or the energy stored by the delayed energy storage mechanism is insufficient to drive the operating device to be opened. That is, the delayed energy storage mechanism is insufficient to drive the real-time energy storage mechanism to drive the isolation switch to be opened (in other words, the energy stored by the delayed energy storage mechanism is insufficient to make the real-time energy storage mechanism complete the energy storage and enter the energy release process). In the present embodiment, when or before the operating shaft 1-4 arrives at the closing position, the turntable 1-9 arrives at the energy storage position, so as to ensure that the delayed energy storage mechanism can complete the energy storage during the closing operation of the operating shaft 1-4, and avoid the failure of energy storage of the delayed energy storage mechanism, resulting in the failure of the remote opening control operation. When the locking mechanism is driven by the tripping mechanism to unlock the turntable 1-9, the first energy storage spring 1-8 releases energy and drives the turntable 1-9 to rotate from the energy storage position to the energy release position, the first energy storage spring 1-8 is switched to the energy release state, and the turntable 1-9 drives the operating shaft 1-4 to rotate from the closing position to the opening position.

As shown in FIGS. 2-7, the lock catch 1-6 of the locking mechanism includes a lock catch latching portion 1-61. The turntable 1-9 is coaxially arranged with the operating shaft 1-4 and includes a locking arm latching surface 1-921. The locking arm latching surface 1-921 is in locking fit with the lock catch latching portion 1-61, so that the turntable 1-9 is kept at the energy storage position. When the turntable 1-9 is located at the energy release position, the locking arm latching surface 1-921 faces away from the lock catch latching portion 1-61. When the turntable 1-9 is located at the energy storage position, the locking arm latching surface 1-921 faces and is in locking fit with the lock catch latching portion 1-61. When or before the operating shaft 1-4 arrives at the closing position, the locking arm latching surface 1-921 rotates past the lock catch latching portion 1-61 and, after the operating shaft 1-4 arrives at the closing position such that the energy storage structure is switched to the closed state, the locking arm latching surface 1-921 is in limiting fit with the lock catch latching portion 1-61 to prevent the turntable 1-9 from rotating to the opening position, such that the energy storage process of the delayed energy storage mechanism is completed synchronously with the closing process (i.e., the process of the operating shaft 1-4 rotating from the opening position to the closing position) of the operating device 1, or the former is completed earlier than the latter, thereby ensuring that the delayed energy storage mechanism successfully completes the energy storage and ensuring the effectiveness of the remote opening control function. That is to say, at a moment when the operating shaft 1-4 rotates to the closing position such that the operating device 1 is switched to the closed state, the locking arm latching surface 1-921 rotates past the lock catch latching portion 1-61 and arrives at the energy storage position, and the locking arm latching surface 1-921 is in limiting fit with the lock catch latching portion 1-61, so that the turntable 1-9 is kept at the energy storage position. Alternatively, in the process of the operating shaft 1-4 rotating from the opening position to the closing position, the operating shaft 1-4 rotates to a preset position but does not reach the closing position, the locking arm latching surface 1-921 rotates past the lock catch latching portion 1-61. After the operating shaft 1-4 continues to rotate to the closing position so that the operating device 1 is switched to the closed state, the first energy storage spring 1-8 drives the turntable 1-9 to rotate back (that is, the turntable 1-9 rotates to the energy release position) by a small angle, the locking arm latching surface 1-921 is in limiting fit with the lock catch latching portion 1-61, so that the turntable 1-9 is kept at the energy storage position. After the tripping mechanism receives a tripping signal, the tripping unit 1-11 acts to drive the lock catch 1-6 to release locking fit from the turntable 1-9, the first energy storage spring 1-8 releases energy and drives the turntable 1-9 to rotate from the energy storage position to the energy release position, and the turntable 1-9 drives the operating shaft 1-4 to rotate from the closing position to the opening position.

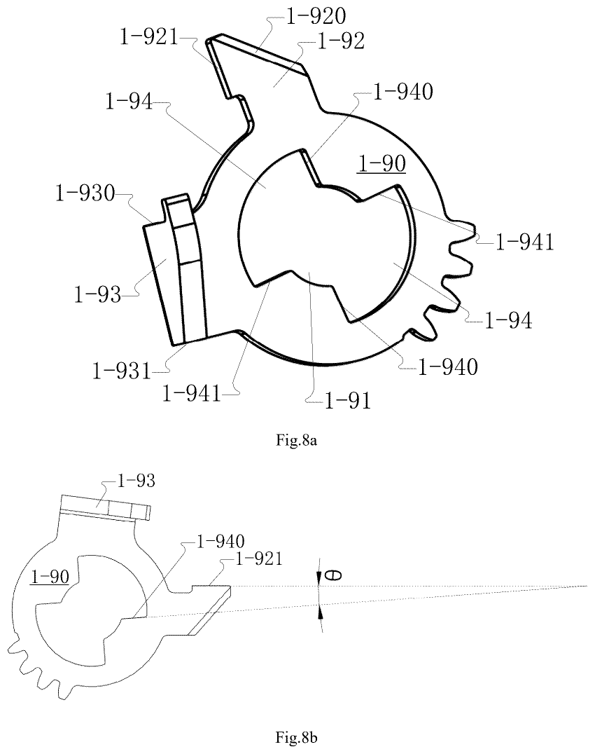

As shown in FIGS. 7-8b, the turntable 1-9 further includes a first surface 1-940, and a rotation axis of the turntable 1-9 is located on an extended surface of the first surface 1-940. The energy storage structure further includes a driving finger which is arranged on the operating shaft 1-4 and rotates synchronously with the operating shaft 1-4. The driving finger in the present embodiment is a driving key 1-10 that protrudes radially on the operating shaft 1-4, and the driving finger is in transmission fit with the first surface 1-940 to drive the turntable 1-9 to rotate to the energy storage position. Further, the turntable 1-9 includes a turntable shaft hole 1-91 and at least one turntable driven hole 1-94, wherein the first surface 1-940 is arranged on a side wall of the turntable driven hole 1-94. The operating shaft 1-4 passes through the turntable shaft hole 1-91, and the driving finger is located in the turntable driven hole 1-94.

Further, one end of the locking arm latching surface 1-921 away from the rotation axis of the turntable 1-9 is offset to a side where the first surface 1-940 is located with respect to one end of the locking arm latching surface 1-921 close to the rotation axis of the turntable 1-9 (that is, the locking arm latching surface 1-921 is gradually inclined to the first surface 1-940 from one end close to the rotation axis of the turntable 1-9 to one end away from the rotation axis of the turntable 1-9, and a vertical distance between one end of the locking arm latching surface 1-921 close to the rotation axis of the turntable 1-9 and the first surface 1-940 is greater than a vertical distance between one end of the locking arm latching surface 1-921 away from the rotation axis of the turntable 1-9 and the first surface 1-940); the locking arm latching surface 1-921 is arranged close to the energy release position of the turntable 1-9 with respect to the first surface 1-940, and the first surface 1-940 is arranged close to the energy storage position of the turntable 1-9 with respect to the locking arm latching surface 1-921; the locking arm latching surface 1-921 is located on the outer side of the first surface 1-940 in a radial direction of the turntable 1-9; an included angle between extended surfaces of the locking arm latching surface 1-921 and the first surface 1-940 respectively is greater than or equal to 0° and less than or equal to 10°; this included angle is θ, and when θ=0°, the turntable 1-9 arrives at the energy storage position while the operating shaft 1-4 arrives at the closing position, and when θ>0° and ≤10°, the turntable 1-9 arrives at the energy storage position before the operating shaft 1-4 arrives at the closing position, so that when or before the operating shaft 1-4 arrives at the closing position, the locking arm latching surface 1-921 rotates past the lock catch latching portion 1-61 of the lock catch 1-6, so that the delayed energy storage mechanism completes the energy storage operation. Further, the radial direction of the turntable 1-9 refers to a direction in which an axis of the turntable 1-9 radiates outward within a plane where the turntable 1-9 is located.

Specifically, in the directions shown in FIG. 8a, up, down, left and right directions in FIG. 8a are up, down, left and right directions of the turntable 1-9, and the locking arm latching surface 1-921 is inclined to the right side from the lower end to the upper end.

In an automatic transfer switch in the present embodiment, in order to achieve a remote opening control function without affecting the manual opening function: when the turntable 1-9 is located at the energy storage position, the operating shaft 1-4 is avoided, and when the operating device 1 is in the closed state, that is, when the operating shaft 1-4 is in the closing position, there is an opening idle stroke between the turntable 1-9 and the operating shaft 1-4; and when the operating shaft 1-4 rotates from the closing position to the opening position and drives the operating device 1 to be switched to the opened state, the operating shaft travels through the opening idle stroke with respect to the turntable 1-9 and does not drive the turntable 1-9 to rotate, that is, does not change a state of the delayed energy storage mechanism.

As shown in FIGS. 7-8b, further, an opening idle stroke is arranged in the turntable driven hole 1-94; and when the turntable 1-9 is located at the energy storage position and the operating shaft 1-4 rotates from the closing position to the opening position, the driving finger travels through the opening idle stroke and the turntable 1-9 remains stationary. Further, a side wall of the turntable driven hole 1-94 is further provided with a second surface 1-941. The second surface 1-941 and the first surface 1-940 are located at both ends of a driving finger stroke. The first surface 1-940 and the second surface 1-941 are two side surfaces oppositely arranged at intervals in the turntable driven hole 1-94. The opening idle stroke is arranged between the first surface 1-940 and the second surface 1-941. When the operating shaft 1-4 is located at the closing position, the opening idle stroke is formed between the second surface 1-941 and the driving finger.

When the operating shaft 1-4 is located at the opening position and the turntable 1-9 is located at the energy release position, the driving finger is in contact with or close to the first surface 1-940. When the operating shaft 1-4 rotates from the opening position to the closing position, the first surface 1-940 is pushed by the driving finger to drive the turntable 1-9 to rotate from the energy release position to the energy storage position. The turntable 1-9 drives the first energy storage spring 1-8 to store energy, and when or before the operating shaft 1-4 arrives at the closing position, the locking arm latching surface 1-921 of the turntable 1-9 rotates past the lock catch latching portion 1-61 and can be locked at the energy storage position by the lock catch 1-6, and the first energy storage spring 1-8 is kept in the energy storage state. When the operating shaft 1-4 is located at the closing position, the driving finger is in contact with or close to the first surface 1-940 to form the opening idle stroke with the second surface 1-941, the operating shaft 1-4 travels through the corresponding opening idle stroke when rotating from the closing position to the opening position. The driving finger rotates between the first surface 1-940 and the second surface 1-941, but does not drive the turntable 1-9 to rotate in an opposite direction, that is, does not drive the turntable 1-9 to rotate to the energy release position. When the operating shaft 1-4 is located at the closing position, the driving finger is in contact with or close to the first surface 1-940. When the lock catch 1-6 releases locking fit from the turntable 1-9, the first energy storage spring 1-8 releases energy and drives the turntable 1-9 to rotate from the energy storage position to the energy release position. The turntable 1-9 acts on the driving finger through the first surface 1-940 and drives the operating shaft 1-4 to rotate from the closing position to the opening position.

As shown in FIGS. 7-8b, the turntable 1-9 further includes a turntable main plate 1-90 and a turntable locking arm 1-92. The turntable main plate 1-90 and the operating shaft 1-4 are coaxially arranged. The turntable driven hole 1-94 is formed in the turntable main plate 1-90. The turntable locking arm 1-92 is arranged on an edge of the turntable 1-90. The turntable locking arm 1-92 is provided with the locking arm latching surface 1-921. The locking arm latching surface 1-921 is arranged on an edge of the turntable locking arm 1-92. The locking arm latching surface 1-921 is not coplanar with the turntable main plate 1-90. Further, as shown in FIGS. 8a-8b, a rotation plane of the turntable main plate 1-90 (i.e., a plane where the turntable main plate 1-90 is located) is perpendicular to an axial direction of the operating shaft 1-4, a plane where the turntable locking arm 1-92 is located is parallel to the plane where the turntable main plate 1-90 is located, and the turntable locking arm 1-92 is preferably coplanar with the turntable main plate 1-90.

Specifically, as shown in FIGS. 7-8b, the turntable driven hole 1-94 is a sector-shaped hole, a circle center of which coincides with an axis of the turntable 1-9. The first surface 1-940 and the second surface 1-941 are arranged at both ends of the sector-shaped hole in a circumferential direction thereof, respectively. Further, the two sector-shaped holes are symmetrically formed in two radial sides of the operating shaft 1-4. The delayed energy storage mechanism further includes a driving key 1-10 arranged on the operating shaft 1-4, and both ends of the driving key 1-10 separately protrude from the two radial sides of the operating shaft 1-4 as two driving fingers. Further, a turntable shaft hole 1-91 for the operating shaft 1-4 to pass through is formed in the middle of the turntable main plate 1-90, and radial inner ends of the two sector-shaped holes are both communicated with the turntable shaft hole 1-91. The operating shaft 1-4 is provided with operating shaft insertion holes 1-40 for mounting the driving keys 1-10.

Further, as shown in FIGS. 8a-8b, the turntable locking arm 1-92 includes a locking arm matching portion. The locking arm matching portion is of a triangular plate structure, a first edge of which is connected to the turntable main plate 1-90, a second edge of which is in limiting fit with the locking part latching surface, and a third edge of which is matched with a locking portion guide surface. Further, the turntable locking arm 1-92 includes a turntable locking arm matching surface 1-920 and a turntable locking arm latching surface 1-921. The turntable locking arm matching surface 1-920 is a chamfered slope arranged on the third edge, and matched with a locking portion guide slope. The turntable locking arm latching surface 1-921 is matched with the locking portion latching surface to lock the turntable 1-9 at the energy storage position.

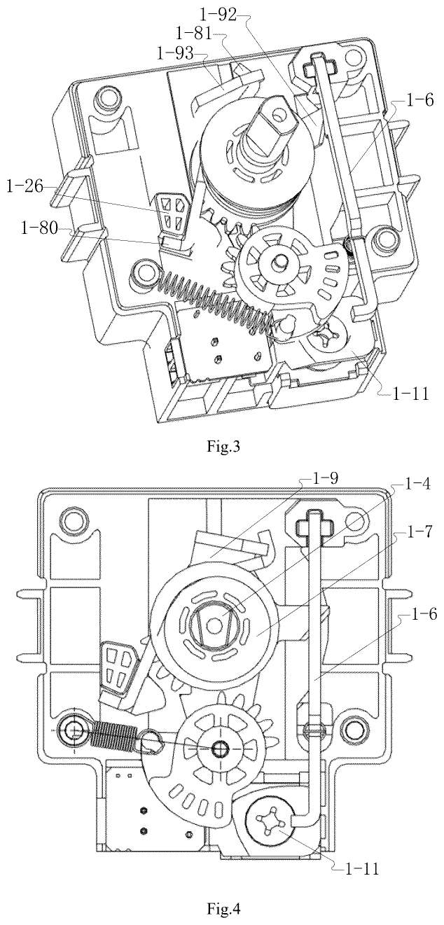

As shown in FIGS. 3-6, the first energy storage spring 1-8 is a torsion spring which is sleeved on the operating shaft 1-4, wherein one end of the torsion spring is a first spring fixed end 1-80 and fixedly arranged (e.g., fixedly arranged on the device housing), and the other end of the torsion spring is a first spring driven end 1-81 and is matched with the turntable 1-9. The turntable 1-9 rotates from the energy release position to the energy storage position and drives the first spring driven end 1-81 to swing, such that the first energy storage spring 1-8 twists and stores energy. Further, the first energy storage spring 1-8 includes a first spring coil body. The first spring coil body is sleeved on the operating shaft 1-4. The first spring fixed end 1-80 and the first spring driven end 1-81 are connected with both ends of the first spring coil body, respectively. Further, as shown in FIGS. 3 and 7, the housing diaphragm 1-2 is provided with a housing diaphragm spring limiting groove 1-25, and the first spring fixed end 1-80 is arranged in the housing diaphragm spring limiting groove 1-25. Further, the housing diaphragm 1-2 is further provided with a turntable stopper 1-26, and the housing diaphragm spring limiting groove 1-25 is formed in the turntable stopper 1-26.

As other embodiments, the first energy storage spring 1-8 is a linear compression spring, wherein one end of this linear compression spring is rotatably arranged on the housing diaphragm 1-2 of the device housing, and the other end of this linear compression spring is rotatably connected to the turntable 1-9. The turntable 1-9 rotates from the energy release position to the energy storage position, such that the first energy storage spring 1-8 is compressed for energy storage. The energy storage position of the turntable 1-9 is in front of a dead center position of the first energy storage spring 1-8, and the dead center position of the first energy storage spring 1-8 refers to a position of the first energy storage spring 1-8 when a geometric axis of the first energy storage spring 1-8 is located in the same straight line with the axis of the turntable 1-9. Of course, when the first energy storage spring 1-8 is a torsion spring, it can also be arranged in the following way: both ends of the torsion spring are rotatably connected to the housing diaphragm 1-2 and the turntable 1-9 respectively, and the dead center position of the first energy storage spring 1-8 at this moment refers to a position of the first energy storage spring 1-8 when both ends of the torsion spring are located in the same straight line with the turntable 1-9. The above implementation will increase an occupied space of the delayed energy storage mechanism, so the first energy storage spring 1-8 in the present embodiment preferably adopts a torsion spring which is rotatably sleeved on the operating shaft 1-4.

As shown in FIGS. 3 and 5-8b, the turntable 1-9 further includes a turntable matching arm 1-93. The first spring driven end 1-81 is matched with the turntable matching arm 1-93. When the turntable 1-9 rotates from the energy release position to the energy storage position, the first spring driven end 1-81 is pushed by the turntable matching arm 1-93 to swing so that the first energy storage spring 1-8 stores energy. Further, the turntable matching arm 1-93 is arranged on an edge of the turntable main plate 1-90, and includes a turntable matching arm limiting side edge 1-931 and a turntable matching arm matching side edge 1-930 which are oppositely arranged. The turntable matching arm limiting side edge 1-931 is in limiting fit with the device housing to limit the turntable 1-9 at the energy release position, and the turntable matching arm matching side edge 1-930 is matched with the first spring driven end 1-81.

Further, the turntable matching arm limiting side edge 1-931 is in limiting fit with the turntable stopper 1-26 of the housing diaphragm 1-2 to limit the turntable 1-9 at the energy release position.

Further, an extension direction of the turntable matching arm 1-93 is perpendicular to the plane where the turntable main plate 1-90 is located.

As shown in FIGS. 2-6, the energy storage structure further includes a first bushing 1-7. The first bushing 1-7 is rotatably sleeved on the operating shaft 1-4. One end of the first bushing 1-7 is matched with the turntable 1-9 to limit the turntable 1-9 on the turntable bearing structure, and the other end of the first bushing 1-7 is limited to prevent the first bushing 1-7 from moving away from the turntable 1-9 in the axial direction of the operating shaft 1-4, which is conducive to keeping the turntable 1-9 in a horizontal state (i.e., a state perpendicular to the axial direction of the operating shaft 1-4), avoiding the turntable 1-9 from warping under a torsional torque of the first energy storage spring 1-8, and ensuring the reliable and stable operation of the delayed energy storage mechanism. The first spring coil body of the first energy storage spring 1-8 is sleeved on the first bushing 1-7, so that the operating shaft 1-4 can be prevented from being locked when the first energy storage spring 1-8 twists and stores energy, and the first energy storage spring 1-8 can be well fixed to prevent its deflection, thereby ensuring the reliable and stable operation of the delayed energy storage mechanism.

Further, as shown in FIGS. 2-6 and 9, the first bushing 1-7 includes a first bushing head 1-71 and a first bushing body 1-70 which are arranged coaxially. The first bushing head 1-71 has an outer diameter greater than an outer diameter of the first bushing body 1-70 and an outer diameter of the first spring coil body. One end of the first bushing body 1-70 is connected to the first bushing head 1-71, and the other end of the first bushing body 1-70 is matched with the turntable 1-9. The first spring coil body is sleeved on the first bushing body 1-70, and is reliably limited between the first bushing head 1-71 and the turntable 1-9.

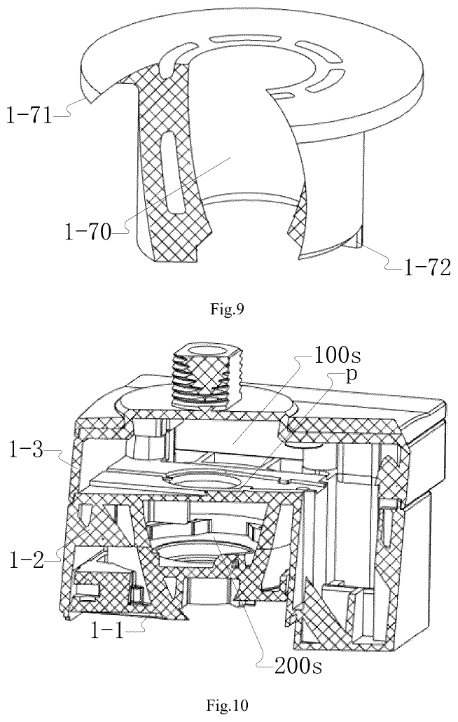

Further, the first bushing 1-7 is coaxially and fixedly connected to and arranged in synchronous rotation with the turntable 1-9. The first bushing 1-7 provides radial support for the turntable 1-9, avoids radial friction between the turntable 1-9 and the operating shaft 1-4, improves the action fluency of the turntable 1-9, also reduces the wear of the turntable 1-9 and the operating shaft 1-4, and prolongs the service life of the product. Further, as shown in FIGS. 6 and 9, bushing protrusions 1-72 are arranged at one end of the first bushing 1-7, the turntable 1-9 is provided with turntable holes, and the bushing protrusions 1-72 are inserted in the turntable holes, so that the first bushing 1-7 and the turntable 1-9 are detachably and fixedly connected. Further, the first bushing 1-7 is provided with two sets of bushing protrusions 1-72. The sector-shaped holes of the turntable 1-9 are used as the turntable holes, the two sets of bushing protrusions 1-72 are respectively arranged in the two sets of sector-shaped holes of the turntable 1-9, and the driving keys 1-10 are located between the two sets of bushing protrusions 1-72.

As other embodiments, the first bushing 1-7 and the turntable 1-9 are of an integral structure.

Further, as shown in FIGS. 6-7, the energy storage structure further includes a gasket 1-5. One end of the first bushing 1-7 is in limiting fit with the housing upper cover 1-3, and the other end of the first bushing 1-7 is matched with the turntable 1-9. The gasket 1-5 is arranged on the housing diaphragm 1-2 as the turntable bearing structure. The turntable 1-9 is arranged on the gasket 1-5. The gasket 1-5 forms protection to the housing diaphragm 1-2 to prevent the turntable 1-9 from rotating and wearing the housing diaphragm 1-2, which is conducive to prolonging the service life of the operating device 1 and the energy storage structure. Further, as shown in FIG. 6, the gasket 1-5 is provided with a gasket avoidance hole for the operating shaft 1-4 to pass through, a gasket counterbore formed in one side of the gasket 1-5 facing the turntable 1-9 and a gasket opening for the driving key 1-10 of the delayed energy storage mechanism to pass through. The gasket counterbore has an inner diameter greater than an inner diameter of the gasket avoidance hole and smaller than an outer diameter of the turntable main plate 1270 of the turntable 1-9. The gasket opening is communicated with the gasket counterbore. The driving key 1-10 enters the gasket counterbore through the gasket opening, is inserted on the operating shaft 1-4, and swings in the gasket counterbore. When the operating device is assembled, the operating shaft 1-4 is assembled together with the real-time energy storage mechanism at first, then the delayed energy storage mechanism is assembled, and the gasket opening is convenient for the assembly of the driving key 1-10 and the operating shaft 1-4, thereby improving the assembly efficiency.

As shown in FIGS. 2-7, the lock catch 1-6 of the locking mechanism is rotatably arranged, and includes a lock catch main plate 1-60 and a lock catch latching portion 1-61. In the process of rotating the turntable 1-9 from the energy release position to the energy storage position, the turntable locking arm 1-92 presses against the lock catch latching portion 1-61, such that the lock catch 1-6 rotates in a first direction to avoid the turntable locking arm 1-92. After the turntable locking arm 1-92 crosses over the lock catch latching portion 1-61, the lock catch 1-6 rotates in a second direction to reset and be in limiting fit with the turntable locking arm 1-92 to limit the turntable 1-9 at the energy storage position, such that the delayed energy storage mechanism is kept in the energy storage state. The first direction and the second direction are opposite to each other. Further, the lock catch latching portion 1-61 is arranged on an edge of the lock catch main plate 1-60 facing the turntable 1-9.

Further, as shown in FIGS. 2-7, one end of the lock catch 1-6 is arranged pivotally, and the other end of the lock catch 1-6 is in driving fit with the tripping unit 1-11 of the tripping mechanism. The tripping unit 1-11 causes the lock catch latching portion 1-61 to release locking fit with the turntable locking arm 1-92 by driving the lock catch 1-6 to rotate in an unlocking direction (i.e., the first direction).

Further, as shown in FIG. 5, the lock catch latching portion 1-61 includes a lock catch latching surface. The lock catch latching surface is located on one side of a straight line that extends along an extension direction of the lock catch main plate 1-60 and passes through a rotation center of the lock catch 1-6.

Further, as shown in FIG. 5, the lock catch latching portion 1-61 includes a locking portion guide surface and a locking portion latching surface. The turntable locking arm 1-92 presses against the locking portion guide surface, such that the lock catch 1-6 rotates in the first direction, and the turntable locking arm 1-92 is in limiting fit with the locking portion latching surface to lock the turntable 1-9 at the energy storage position.

As shown in FIG. 6, the locking mechanism further includes a lock catch resetting element 1-7r. The lock catch resetting element 1-7r exerts an acting force to the lock catch 1-6, which makes the lock catch 1-6 rotate to the second direction (i.e., a locking direction) to reset and is also used to make the lock catch latching portion 1-61 keep in limiting fit with the turntable locking arm 1-92 of the turntable 1-9, and the turntable 1-9 is locked at the energy storage position.

As shown in FIGS. 2-4 and 7, the tripping mechanism includes a tripping unit 1-11. The tripping unit 1-11 is preferably a magnetic flux tripping unit, which is used for driving the lock catch 1-6 to act to release locking fit with the delayed energy storage mechanism. After the tripping mechanism receives a tripping signal (i.e., a remote opening control signal), the tripping unit 1-11 acts to drive the lock catch 1-6 to release locking fit with the delayed energy storage mechanism.

The real-time energy storage mechanism and the tripping mechanism of the isolation switch of the present invention can be implemented by the prior art, and will not be described here.

It should be explained that, in the description of the present invention, the terms such as “up”, “down”, “left”, “right”, “inner” and “outer” indicating the directional or positional relations on the basis of the directional or positional relations shown in the drawings are only used for conveniently describing the present invention and simplifying the description, not indicate or imply that the referred devices or elements must have a specific orientation and be configured and operated in a specific direction; therefore, they cannot be construed as a limitation on the present invention.

We have made further detailed description of the present invention mentioned above in combination with specific preferred embodiments, but it is not deemed that the specific embodiments of the present invention is only limited to these descriptions. A person skilled in the art can also, without departing from the concept of the present invention, make several simple deductions or substitutions, which all be deemed to fall within the protection scope of the present invention.

1. An energy storage structure, comprising an operating shaft, a delayed energy storage mechanism and a locking mechanism, wherein the delayed energy storage mechanism comprises a first energy storage spring and a turntable; the operating shaft rotates between an opening position and a closing position, the turntable rotates between an energy release position and an energy storage position, and the locking mechanism is used for locking the turntable at the energy storage position;
the operating shaft is in driving fit with the turntable, and when the operating shaft rotates from the opening position to the closing position, the turntable rotates from the energy release position to the energy storage position with the rotation of the operating shaft, and drives the first energy storage spring to store energy at the same time; and
the turntable is coaxially arranged with the operating shaft; and when or before the operating shaft arrives at the closing position, the turntable arrives at the energy storage position.

2. The energy storage structure according to claim 1, wherein the locking mechanism comprises a lock catch, and the lock catch comprises a lock catch latching portion; the turntable comprises a locking arm latching surface, and the locking arm latching surface is in locking fit with the lock catch latching portion, so that the turntable is kept at the energy storage position; and when or before the operating shaft arrives at the closing position, the locking arm latching surface rotates past the lock catch latching portion.

3. The energy storage structure according to claim 2, wherein the turntable comprises a first surface, a driving finger is arranged on the operating shaft, and the driving finger is in transmission fit with the first surface to drive the turntable to rotate toward the energy storage position; one end of the locking arm latching surface away from a rotation axis of the turntable is offset to a side, where the first surface is located, with respect to one end of the locking arm latching surface close to the rotation axis of the turntable the locking arm latching surface is located on an outer side of the first surface in a radial direction of the turntable; and an included angle between extended surfaces of the locking arm latching surface and the first surface is greater than or equal to 0° and less than or equal to 10°.

4. The energy storage structure according to claim 1, wherein when the locking mechanism unlocks the turntable, the first energy storage spring releases energy and drives the turntable to rotate from the energy storage position to the energy release position, and the turntable drives the operating shaft to rotate from the closing position to the opening position.

5. The energy storage structure according to claim 3, wherein the turntable comprises a turntable shaft hole and at least one turntable driven hole, the operating shaft passes through the turntable shaft hole, and a side wall of the turntable driven hole is provided with first surface.

6. The energy storage structure according to claim 5, wherein when the turntable is located at the energy storage position, the operating shaft rotates freely between the opening position and the closing position.

7. The energy storage structure according to claim 6, wherein there is an opening idle stroke between the turntable and the operating shaft; and when the operating shaft rotates from the closing position to the opening position, the operating shaft travels through the opening idle stroke with respect to the turntable. (Currently Amended) The energy storage structure according to claim 7, wherein the opening idle stroke is arranged in the turntable driven hole; and when the turntable is located at the energy storage position and the operating shaft rotates from the closing position to the opening position, the driving finger travels through the opening idle stroke and the turntable remains stationary.

9. The energy storage structure according to claim 8, wherein the turntable driven hole is a sector-shaped hole, a circle center of which coincides with an axis of the turntable; the first surface and a second surface are arranged at both ends of the sector-shaped hole in a circumferential direction thereof, respectively; and the opening idle stroke is arranged between the first surface and the second surface.

10. The energy storage structure according to claim 5, wherein the turntable further comprises a turntable main plate and a turntable locking arm; the turntable driven hole is formed in the turntable main plate; the turntable locking arm is arranged on an edge of the turntable; the locking arm latching surface is arranged on an edge of the turntable locking arm; and the locking arm latching surface is not coplanar with the turntable main plate.

11. The energy storage structure according to claim 1, further comprising a first bushing that is rotatably sleeved on the operating shaft; and the first energy storage spring is a torsion spring sleeved on the first bushing, wherein one end of the torsion spring is matched with the turntable, and another end of the torsion spring is fixedly arranged.

12. The energy storage structure according to claim 11, wherein the first bushing is coaxially and fixedly connected to and arranged in synchronous rotation with the turntable; the first bushing comprises a first bushing head and a first bushing body that are coaxially arranged; the first bushing head has an outer diameter greater than an outer diameter of the first bushing body and an outer diameter of a first spring coil body; and one end of the first bushing body is connected to the first bushing head, another end of the first bushing body is matched with the turntable, and the first spring coil body is sleeved on the first bushing body.

13. The energy storage structure according to claim 12, wherein the first bushing is provided with bushing protrusions, the turntable is provided with turntable holes, and the bushing protrusions are inserted in the turntable holes.

14. The energy storage structure according to claim 11, further comprising a housing upper cover, a housing diaphragm and a gasket, wherein one end of the first bushing is in limiting fit with the housing upper cover, and another end of the first bushing body is matched with the turntable; the gasket is arranged on the housing diaphragm as a turntable bearing structure; and the turntable is arranged on the gasket.

15. A rotary isolation switch, comprising the energy storage structure according to claim 1.
